(19) United States
(12) Patent Application Publication
(10) Pub. No.: US 2014/0184678 A1
(43) Pub. Date: Jul. 3, 2014

(54) HEAD CHIP, METHOD OF MANUFACTURING HEAD CHIP, LIQUID JET HEAD, AND LIQUID JET APPARATUS

(71) Applicant: SII PRINTEK INC., Chiba (JP)

(72) Inventor: Yoshinori DOMAE, Chiba (JP)

(73) Assignee: SII PRINTEK INC., Chiba (JP)

(21) Appl. No.: 14/103,908

(22) Filed: Dec. 12, 2013

(30) Foreign Application Priority Data
Dec. 28, 2012 (JP) 2012-288673

(51) Int. Cl. B41J 2/14; B41J 2/16

(52) U.S. Cl. CPC B41J 2/1433; B41J 2/162
USPC 347/12; 29/890.1; 347/40

(57) ABSTRACT

In a head chip, a cover plate includes a positioning reference provided at a position facing at least one of nozzle holes through at least one liquid jet channel. The positioning reference can be detected from underneath the nozzle plate through the nozzle hole and the liquid jet channel. A method of manufacturing the head chip includes a positioning step for positioning the nozzle plate by detecting the positioning reference provided in the cover plate.

### BACKGROUND

1. Technical Field

The present invention relates to a head chip of a liquid jet head which ejects liquid droplets, a method of manufacturing the head chip, and a liquid jet head and a liquid jet apparatus using the head chip.

2. Related Art

Conventionally, in a head chip of a liquid jet head, when bonding a nozzle plate having a plurality of nozzle holes formed thereon to an actuator plate having a plurality of ejection grooves formed thereon, in order to position the nozzle holes of the nozzle plate so as to overlap with the respective ejection grooves of the actuator plate, a positioning reference such as a hole other than the nozzle holes is formed on the nozzle plate, and the alignment between the actuator plate and the nozzle plate is performed using the positioning reference (see JP 9-20009 A and JP 2002-96473 A, for example).

In JP 9-20009 A, an edge shoot type head chip in which a nozzle plate is placed on the distal ends in the longitudinal direction of a plurality of ejection grooves in an actuator plate is disclosed. In the head chip, dummy grooves are formed on the actuator plate at positions outside both ends in the arrangement direction of the ejection grooves. Further, a plurality of small holes are formed on the nozzle plate across the peripheral edges of the distal ends of the dummy grooves. The alignment between the actuator plate and the nozzle plate is performed by detecting the peripheral edges of the distal ends of the dummy grooves by the small holes.

In JP 2002-96473 A, a head chip in which a nozzle plate is placed on one surface of the actuator plate is disclosed. In the head chip, alignment holes are formed on the actuator plate at positions outside both ends of an ejection groove group. Also, alignment holes are formed on the nozzle plate at positions outside both ends of a nozzle hole group. The alignment between the actuator plate and the nozzle plate is performed by these alignment holes.

### SUMMARY

However, in the above conventional configuration, since the alignment between the actuator plate and the nozzle plate is performed at the positions away from the nozzle holes, the size tolerance between the positioning reference and the nozzle holes disadvantageously affects the positioning accuracy of the nozzle holes. Further, when the nozzle plate is a thin resin plate or the like, displacement caused by thermal deformation of the nozzle plate further disadvantageously affects the positioning accuracy of the nozzle holes.

Especially in a side shoot type head chip in which each nozzle hole communicates with the middle part in the longitudinal direction of each ejection groove, it is preferred to arrange each nozzle hole on the center in the longitudinal direction of each ejection groove. That is, drive walls which drive ejection grooves and the ejection grooves to which pressure waves caused by the drive walls are transmitted are symmetrically formed with respect to the centers in the longitudinal direction of the respective ejection grooves, and the nozzle holes are placed on the centers (namely, the center of a pump driving unit of the actuator plate). As a result, liquid droplets are efficiently and stably ejected.

However, in the above conventional configuration, the positioning is indirectly performed, and the center in the longitudinal direction of each of the ejection grooves becomes unclear when the nozzle plate overlaps with the ejection grooves. Therefore, even if trying to accurately position each of the nozzle holes on the center in the longitudinal direction of each of the ejection grooves that are substantially longer than the nozzle holes, it is not clear whether the nozzle holes are actually arranged on desired positions.

Therefore, a structure capable of accurately and reliably positioning each of the nozzle holes on the center in the longitudinal direction of each of the ejection grooves in alignment between the actuator plate and the nozzle plate is desired.

The present invention has been made in view of the above problems, and is directed to make it possible, in a head chip that is provided with an actuator plate, a cover plate and a nozzle plate and a method of manufacturing the head chip, to accurately and reliably position nozzle holes, and also provide a liquid jet head and a liquid jet apparatus using the head chip.

As a solution to the above problems, a head chip of the present invention includes an actuator plate having a plurality of ejection grooves formed on a first surface of a substrate, each of the ejection grooves having a depth penetrating the substrate; a cover plate placed on the first surface of the actuator plate, the cover plate having a liquid supply chamber communicating with the ejection grooves; and a nozzle plate placed on a second surface of the actuator plate, the nozzle plate having a plurality of nozzle holes each communicating with the center in the longitudinal direction of each of the ejection grooves. The cover plate has at least one positioning reference for the nozzle plate at a position facing at least one of the nozzle holes through at least one of the ejection grooves, or a position facing at least one adjacent hole adjacent to any of the nozzle holes formed on the nozzle plate through at least one through portion formed on the actuator plate. In the head chip, the at least one positioning reference can be detected from underneath the nozzle plate through the at least one of the nozzle hole and the at least one of the ejection groove, or through the at least one adjacent hole and the at least one through portion.

In the head chip of the present invention, the at least one positioning reference provided in the cover plate may include a plurality of positioning references.

In this case, the at least one positioning reference may include two positioning references, and the two positioning references may be provided at positions facing two of the nozzle holes arranged on both ends of a nozzle array including the nozzle holes formed on the nozzle plate, or the at least one adjacent hole may include two adjacent holes arranged on the both ends of the nozzle array and the two positioning references may be provided at positions facing the two adjacent holes.

In the head chip of the present invention, the at least one positioning reference may be a through hole formed on the cover plate. Alternatively, the at least one positioning reference may be a light reflection portion formed on the cover plate. Alternatively, the at least one positioning reference may be a light transmission portion formed on the cover plate.

Further, the at least one positioning reference may be a projection portion formed on the cover plate, or may also be a recessed portion formed on the cover plate.

Further, the at least one adjacent hole may include a plurality of adjacent holes, and the at least one positioning reference may be provided so as to face plural ones of the nozzle holes or the adjacent holes

Further, the present invention provides a method of manufacturing a head chip which includes an actuator plate having a plurality of ejection grooves formed on a first surface of a substrate, each of the ejection grooves having a depth penetrating the substrate; a cover plate placed on the first surface of the actuator plate, the cover plate having a liquid supply chamber communicating with the ejection grooves; and a nozzle plate placed on a second surface of the actuator plate, the nozzle plate having a plurality of nozzle holes each communicating with the center in the longitudinal direction of each of the ejection grooves. The method includes a positioning step for positioning the nozzle plate by detecting a positioning reference provided in the cover plate through at least one of the nozzle holes and at least one of the ejection grooves, or through an adjacent hole adjacent to any of the nozzle holes formed on the nozzle plate and a through portion formed on the actuator plate.

The method of the present invention may further includes a hole blocking step for blocking a through hole as the positioning reference provided in the cover plate.

Further, the present invention provides a liquid jet head that includes the head chip according to any one of the above, a liquid supply/discharge unit supplying and discharging liquid to and from the ejection grooves, and a control unit applying a drive voltage to drive electrodes formed on side walls of the ejection grooves.

Further, the present invention provides a liquid jet apparatus that includes the above liquid jet head, a conveyance unit conveying a recording medium in a predetermined conveyance direction, and a scanning unit moving the liquid jet head in a direction perpendicular to the conveyance direction with respect to the recording medium.

According to the present invention, the nozzle holes can be directly positioned by a method in which the positioning reference provided in the cover plate is detected through the nozzle hole or the adjacent hole adjacent to the nozzle hole, and the positioning of the nozzle holes is performed by the detection. Therefore, the positioning accuracy the nozzle holes can be improved, and an excellent ejection characteristic of the head chip can thereby be ensured in comparison with the case where the positioning of the nozzle holes is performed by using a positioning reference away from the nozzle holes. Especially in a side shoot type head chip in which each of the nozzle holes communicates with the middle part in the longitudinal direction of each of the ejection grooves, it is important to arrange the nozzle holes on the center of a pump composed of the actuator plate and the cover plate in controlling the ejection characteristic. Therefore, a high effect of the present invention can be achieved in such a side shoot type head chip.

### BRIEF DESCRIPTION OF DRAWINGS

FIG. 1 is a perspective view of a liquid jet recording apparatus that is provided with a liquid jet head that includes a head chip in an embodiment of the present invention;

FIG. 2 is plan view of the head chip when viewed from underneath a nozzle plate;

FIG. 3 is a cross-sectional view taken along line of FIG. 2;

FIG. 4 is a cross-sectional view taken along line IV-IV of FIG. 3;

FIG. 5 is a cross-sectional view taken along line V-V of FIG. 3;

FIG. 6 is a flowchart illustrating main steps of a method of manufacturing the head chip;

FIG. 7 is a cross-sectional view corresponding to FIG. 4 and FIG. 5 in a groove forming step of the manufacturing method;

FIG. 8 is a cross-sectional view corresponding to FIG. 4 in the groove forming step;

FIG. 9 is a cross-sectional view corresponding to FIG. 5 in the groove forming step;

FIG. 10 is a plan view of a piezoelectric substrate in the groove forming step;

FIG. 11 is a cross-sectional view corresponding to FIG. 3 in a conductor deposition step of the manufacturing method;

FIG. 12 is a cross-sectional view corresponding to FIG. 3 in an electrode forming step of the manufacturing method;

FIG. 13 is a cross-sectional view corresponding to FIG. 4 in a cover plate placing step of the manufacturing method;

FIG. 14 is a cross-sectional view corresponding to FIG. 5 in the cover plate placing step of the manufacturing method;

FIG. 15 is a cross-sectional view corresponding to FIG. 4 in a substrate grinding step of the manufacturing method;

FIG. 16 is a cross-sectional view corresponding to FIG. 5 in the substrate grinding step of the manufacturing method;

FIG. 17 is a cross-sectional view corresponding to FIG. 4, illustrating a method of positioning a nozzle plate in a nozzle plate placing step of the manufacturing method;

FIG. 18 is a plan view illustrating disassembled components of the head chip in a vertically arranged state;

FIG. 19 is a plan view corresponding to FIG. 18, illustrating a modified example of the head chip; and

FIG. 20 is a plan view corresponding to FIG. 18, illustrating another modified example of the head chip.

### DETAILED DESCRIPTION

Hereinbelow, an embodiment of the present invention will be described with reference to the accompanying drawings. In the following embodiment, a liquid jet head which ejects ink as liquid, a head chip of the liquid jet head, and a liquid jet recording apparatus provided with the liquid jet head will be described as examples.

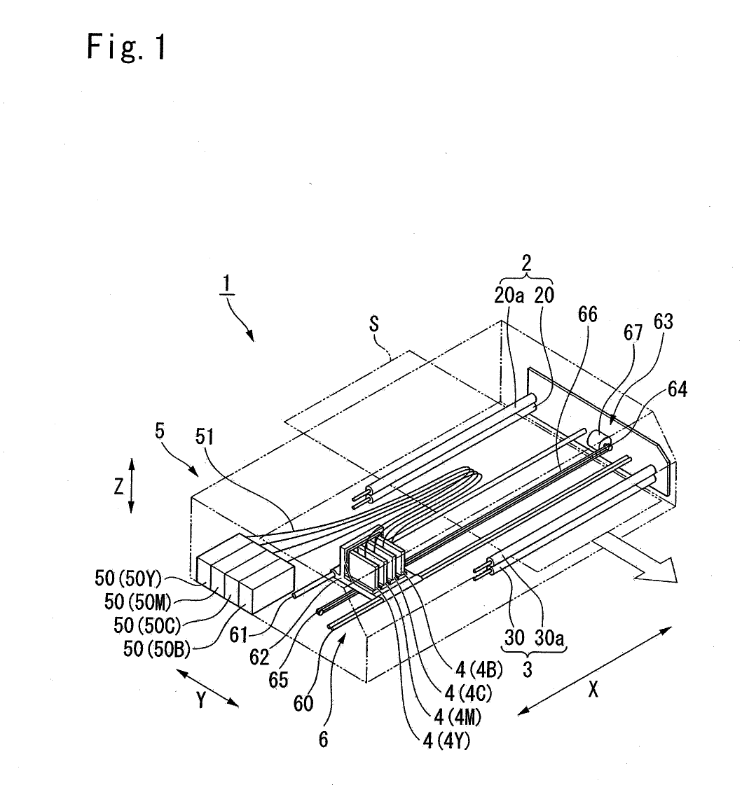

As illustrated in FIG. 1, a liquid jet recording apparatus 1 is provided with a pair of conveyance units (recording medium conveyance units) 2 and 3 which conveys a recording medium S such as paper, a liquid jet head 4 which jets ink onto the recording medium S, an ink supply unit (liquid supply unit) 5 which supplies ink to the liquid jet head 4, and a scanning unit 6 which moves the liquid jet head 4 in a direction that is perpendicular to a conveyance direction of the recording medium S, namely, the width direction of the recording medium S. In the following description, the with direction of the recording medium S is referred to as an X direction, and the conveyance direction of the recording medium S is referred to as a Y direction. In FIG. 1, a Z direction indicates the height direction that is perpendicular to the X direction and the Y direction.

The conveyance unit 2 includes a grid roller 20 which extends in the X direction, a pinch roller 20a which extends in parallel to the grid roller 20, and a drive mechanism (not illustrated) such as a motor which rotates the grid roller 20 about the shaft thereof. Similarly, the conveyance unit 3 includes a grid roller 30 which extends in the X direction, a pinch roller 30a which extends in parallel to the grid roller 30, and a drive mechanism (not illustrated) which rotates the grid roller 30 about the shaft thereof.

The ink supply unit 5 includes an ink tank 50 which stores ink therein and an ink pipe 51 which connects the ink tank 50 to the liquid jet head 4. As the ink tank 50, for example, ink tanks 50Y, 50M, 50C, and 50B which respectively store therein four colors of ink: yellow, magenta, cyan, and black are arranged in the Y direction. The ink pipe 51 includes a flexible hose having flexibility that can cope with the operation of a carriage 62 which supports the liquid jet head 4.

The scanning unit 6 includes a pair of guide rails 60 and 61 each of which extends in the X direction, the carriage 62 which can slide along the pair of guide rails 60 and 61, and a drive mechanism 63 which moves the carriage 62 in the X direction. The drive mechanism 63 includes a pair of pulleys 64 and 65 which are provided between the guide rail 60 and the guide rail 61, an endless belt 66 which is wound around the pair of pulleys 64 and 65, and a drive motor 67 which drives the pulley 64 to rotate.

The pulley 64 is provided between one end of the guide rail 60 and one end of the guide rail 61, and the pulley 65 is provided between the other end of the guide rail 60 and the other end of the guide rail 61. The endless belt 66 is provided between the guide rail 60 and the guide rail 61. The carriage 62 is coupled to the endless belt 66. The carriage 62 loads thereon a plurality of liquid jet heads 4, namely, liquid jet heads 4Y, 4M, 4C, and 4B which respectively eject four colors of ink: yellow, magenta, cyan and black, and arranged in the X direction.

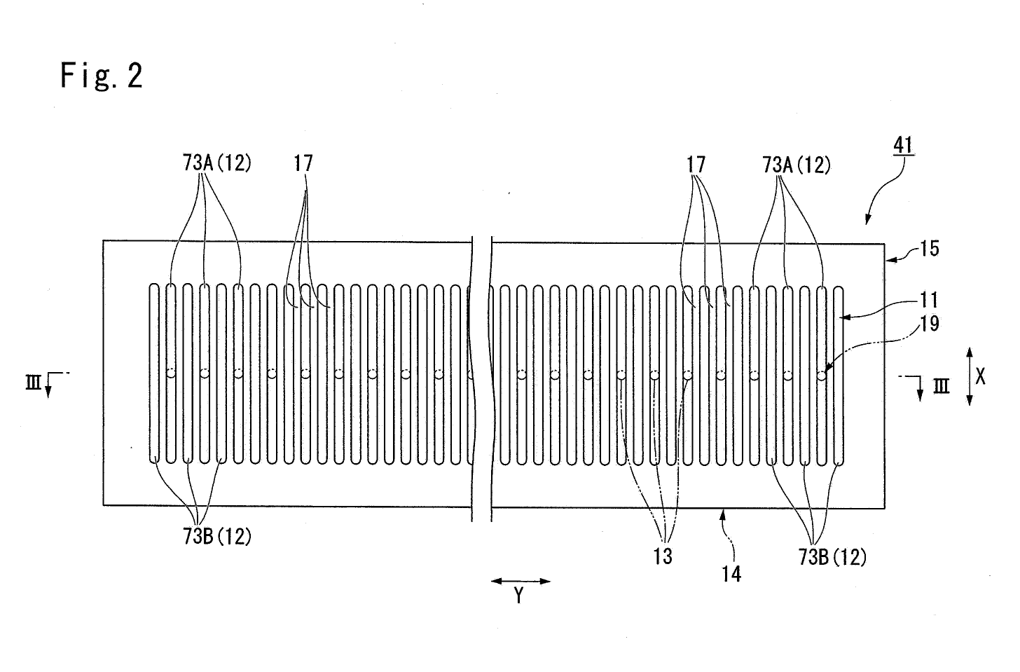

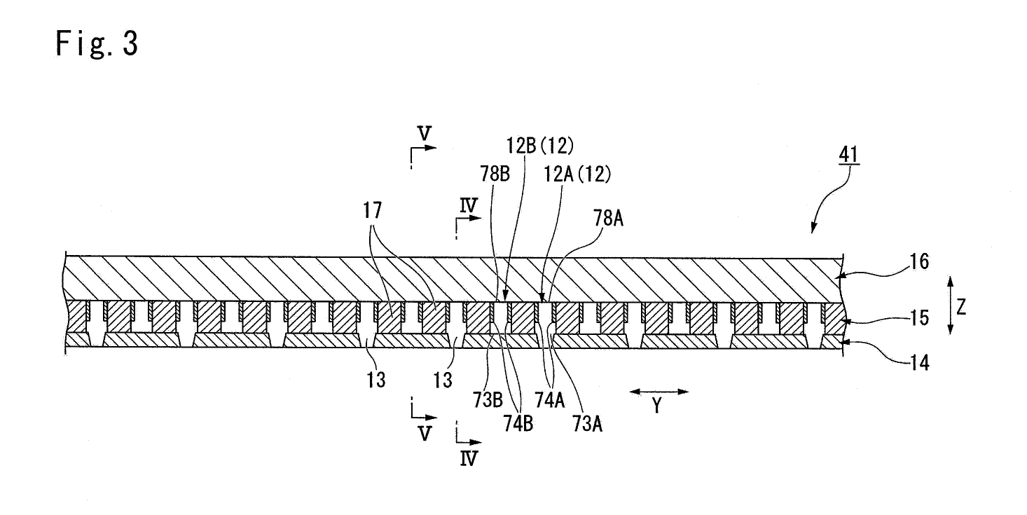

The liquid jet head 4 supports one or more head chips 41 (see FIGS. 2 and 3 etc.), and also supports a liquid supply/discharge unit which supplies and discharges liquid to and from ejection grooves of the head chip 41, a filter unit, a wiring board and the like (all of which are not illustrated), on a base which is fixed to the carriage 62. A control circuit which controls the head chip 41 to drive is formed on the wiring board. The liquid jet head 4 applies a drive voltage to drive electrodes which are formed on side walls of the ejection grooves from the control circuit according to a drive signal output from a control device (not illustrated), and thereby ejects respective colors of ink with a desired volume. The liquid jet head 4 is moved in the X direction by the scanning unit 6 to perform recording on the recording medium S within a predetermined width in the Y direction. Further, the liquid jet head 4 is repeatedly moved in the X direction while conveying the recording medium S in the Y direction by the conveyance units 2 and 3 to perform the recording on the entire recording medium S.

As illustrated in FIGS. 2 and 3, the head chip 41 is formed into a band plate that has a predetermined width in the X direction and extends in the Y direction. The head chip 41 is a liquid circulation type head chip which performs supply and discharge of ink with the liquid supply/discharge unit. The head chip 41 ejects ink from a nozzle array 19 which includes a plurality of nozzle holes 13. The nozzle holes 13 are linearly arranged along the Y direction. The head chip 41 is a so-called side shoot type head chip, and ejects ink from the nozzle holes 13 each of which is formed on the center in the longitudinal direction of each of liquid jet channels 12A which will be described later.

The head chip 41 has a laminated structure of an actuator plate 15, a cover plate 16, and a nozzle plate 14 which are integrally provided. The actuator plate 15 has a channel group 11 which includes a plurality of channels (grooves) 12 arranged in parallel to each other. The cover plate 16 is placed on the upper surface (first surface) of the actuator plate 15. The nozzle plate 14 is placed under the lower surface (second surface) of the actuator plate 15. For the convenience of illustration, the nozzle plate 14 is indicated by a two-dot chain line in FIG. 2.

The actuator plate 15 is formed of, for example, lead zirconate titanate (PZT) ceramics which is polarized in the vertical direction. The cover plate 16 is formed of the same PXT ceramics as the actuator plate 15 so that the thermal expansion of the cover plate 16 is made equal to that of the actuator plate 15, thereby preventing warpage and deformation caused by temperature change. The cover plate 16 may be formed of a material that is different from the material of the actuator plate 15. However, the material of the cover plate 16 preferably has a thermal expansion coefficient similar to that of PZT ceramics. The nozzle plate 14 is formed of a translucent polyimide film.

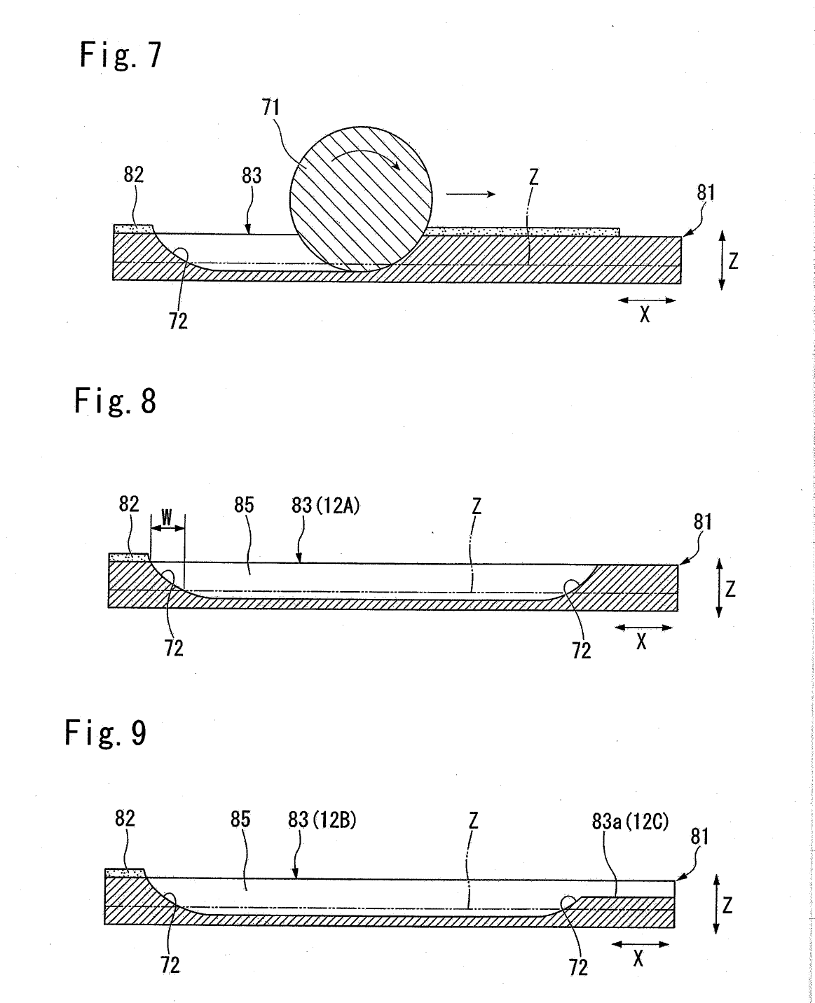

The channels 12 are linearly formed on the actuator plate 15 at regular intervals by cutting the upper surface of the actuator plate 15 using a dicing blade 71 (see FIG. 7) which will be described later. Each of the channels 12 is formed so as to penetrate the actuator plate 15 from the upper surface through the lower surface thereof excepting regions on both ends in the longitudinal direction (X direction) thereof on which arc-shaped bottom surfaces 72 are formed along the outer peripheral shape of the dicing blade 71. Piezoelectric bodies 17 are formed between adjacent ones of the channels 12. Each of the piezoelectric bodies 17 has a rectangular cross section and extends in the X direction.

Each of the channels 12 is roughly classified into a liquid jet channel (ejection groove) 12A that allows ink droplets to be ejected therethrough and a dummy channel (non-ejection groove) 12B that does not allow ink droplets to be ejected therethrough. In the present embodiment, a plurality of liquid jet channels 12A and a plurality of dummy channels 12B are formed so as to be alternately arranged in the Y direction.

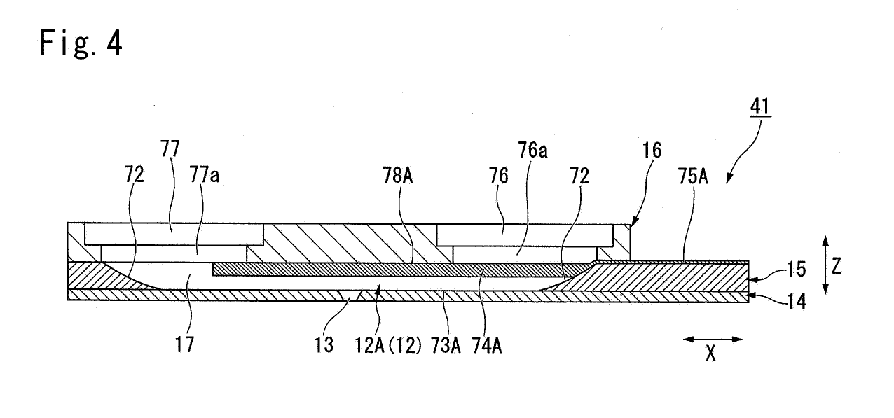

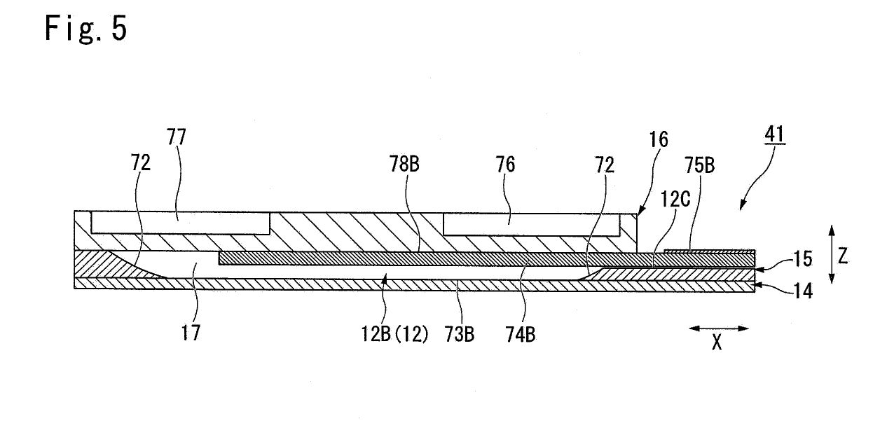

As illustrated in FIGS. 4 and 5, a first end of each of the liquid jet channels 12A and the dummy channels 12B, the first end being positioned on a first side in the X direction (a left side in the drawings), is formed in such a manner that the arc-shaped bottom surface 72 formed by the dicing blade 71 terminates at a position that is relatively slightly inward from a first outer end of the actuator plate 15, the first outer end being positioned on the first side in the X direction.

On the other hand, a second end of each of the liquid jet channels 12A and the dummy channels 12B, the second end being positioned on a second side in the X direction (a right side in the drawings) is formed in such a manner that the arc-shaped bottom surface 72 terminates at a position that is relatively largely inward from a second outer end of the actuator plate 15, the second outer end being positioned on the second side in the X direction.

The liquid jet channels 12A and the dummy channels 12B vertically penetrate the actuator plate 15 within the same range as each other in the X direction.

In each of the dummy channels 12B, a shallow groove 12C having a shallow depth in the Z direction is formed in a position closer to the second end in the X direction in connection to the dummy channel 12B than the position at which the arc-shaped bottom surface 72 on the second end in the X direction of the dummy channel 12B terminates up to the second outer end in the X direction of the actuator plate 15.

The bottoms of the liquid jet channels 12A and the dummy channels 12B are blocked by the nozzle plate 14 which is attached to the lower surface of the actuator plate 15.

Referring to FIGS. 2 and 3, the nozzle plate 14 is provided so as to, for example, have the same width in the X direction and the same length in the Y direction as the actuator plate 15. The nozzle plate 14 has the nozzle holes 13 each of which is positioned below the center in the X direction of each of the liquid jet channels 12A and communicates with each of the liquid jet channels 12A.

The nozzle holes 13 are arranged along the Y direction to form the linear nozzle array 19. The nozzle plate 14 is bonded to the lower surface of the actuator plate 15 with adhesive or the like so as to cover the bottoms (the part corresponding to the actuator plate 15) of the liquid jet channels 12A and the dummy channels 12B. Lower openings 73A of the respective liquid jet channels 12A are blocked by the nozzle plate 14. However, each of the nozzle holes 13 is arranged below the center in the longitudinal direction (the center in the X direction) of each of the liquid jet channels 12A. Lower openings 73B of the respective dummy channels 12B are blocked by regions of the nozzle plate 14, the regions being positioned between adjacent ones of the nozzle holes 13. A method of positioning each of the nozzle holes 13 on the center in the longitudinal direction of each of the liquid jet channels 12A will be described later.

The shape of the lower openings 73A of the liquid jet channels 12A and the shape of the lower openings 73B of the dummy channels 12B, the lower openings 73A and the lower openings 73B being alternately arranged on the lower surface of the actuator plate 15, are the same as each other. However, the shape of the lower openings 73A and the shape of the lower openings 73B may be different from each other. Each of the dummy channels 12B may terminate in the same manner as the liquid jet channels 12A without forming the shallow groove 12C in connection therewith. The dummy channels 12B may not be opened on the lower surface of the actuator plate 15.

Referring to FIG. 4, common electrodes 74A are formed on opposite inner side surfaces of each of the liquid jet channels 12A. The common electrodes 74A are separated upward from the bottom surfaces of the liquid jet channels 12A (the upper surface of the nozzle plate 14). Each of the common electrodes 74A is formed into a band form extending in the X direction. Ends of the common electrodes 74A, the ends being located on the second side in the X direction, are electrically connected to common terminals 75A which are formed on the upper surface of the actuator plate 15 on the second side in the X direction.

Referring to FIG. 5, active electrodes 74B are formed on opposite inner surfaces of each of the dummy channels 12B. The active electrodes 74B are separated upward from the bottom surfaces of the dummy channels 12B (the upper surface of the nozzle plate 14). Each of the active electrodes 74B is formed into a band form extending in the X direction. Ends of the active electrodes 74B, the ends being located on the second side in the X direction, are electrically connected to active terminals 75B which are formed on the upper surface of the actuator plate 15 on the second side in the X direction.

A pair of active electrodes 74B that face each other in each of the dummy channels 12B are electrically separated from each other. Each of the active electrodes 74B is positioned above the bottom surface of the shallow groove 12C, and formed in connection to an inner surface of the shallow groove 12C. Two active electrodes 74B each of which is formed on each of a pair of piezoelectric bodies 17 that define a liquid jet channel 12A therebetween are electrically connected to each other.

In this configuration, when a voltage is applied to the active electrodes 74B formed on the pair of piezoelectric bodies 17 that define the liquid jet channel 12A therebetween, the pair of piezoelectric bodies 17 are deformed, which causes pressure fluctuation in ink that is filled inside the liquid jet channel 12A therebetween. The ink is ejected from the corresponding nozzle hole 13 to thereby record a character or a figure on the recording medium S. A flexible substrate (no illustrated) for connecting the common terminals 75A and the active terminals 75B to the outside is mounted on the actuator plate 15 on the second side in the X direction.

The cover plate 16 is formed into a band plate that extends in the Y direction in the same manner as the actuator plate 15, the band plate having a width narrower than the actuator plate 15 in the X direction as well as having a width wider than the entire length of the channel group 11 of the liquid jet channels 12A and the dummy channels 12B in the Y direction. The cover plate 16 has a liquid supply chamber 76 which is formed on the upper surface thereof on the second side in the X direction (the right side in the drawings) and a liquid discharge chamber 77 which is formed on the upper surface thereof on the first side in the X direction (the left side in the drawings). First slits 76a each of which communicates with each of the liquid jet channels 12A on the second side in the X direction are formed on the bottom (lower part) of the liquid supply chamber 76. Second slits 77a each of which communicates with each of the liquid jet channels 12A on the first side in the X direction are formed on the bottom of the liquid discharge chamber 77.

The cover plate 16 is placed in such a manner that a first outer end thereof, the first outer end being positioned on the first side in the X direction (the left side in the drawings), is aligned with the first outer end in the X direction of the actuator plate 15 to cover the liquid jet channels 12A and the dummy channels 12B, and, on the other hand, a second outer end thereof, the second outer end being positioned on the second side in the X direction (the right side in the drawings), is arranged so that the common terminals 75A and the active terminals 75B are exposed to the outside. The first slits 76a of the cover plate 16 communicate with upper openings 78A of the respective liquid jet channels 12A on the second side in the X direction. The second slits 77a of the cover plate 16 communicate with the upper opening 78A of the respective liquid jet channels 12A on the first end in the X direction. Upper openings 78B of the respective dummy channels 12B do not communicate with the first and second slits 76a and 77a, and are blocked by the lower surface of the cover plate 16.

The cover plate 16 preferably has a thickness in the range of 0.3 mm to 1.0 mm. The nozzle plate 14 preferably has a thickness in the range of 0.01 mm to 0.1 mm. When the cover plate 16 is thinner than 0.3 mm, the strength thereof is reduced. On the other hand, when the cover plate 16 is thicker than 1.0 mm, it takes time for the processing of the liquid supply chamber 76 and the liquid discharge chamber 77, and the first and second slits 76a and 77a. In addition, the manufacturing cost increases due to the increased amount of materials. Further, when the nozzle plate 14 is thinner than 0.01 mm, the strength thereof is reduced. On the other hand, when the nozzle plate 14 is thicker than 0.1 mm, vibration is transmitted between nozzle holes 13 that are adjacent to each other, and crosstalk is thereby likely to occur.

The PZT ceramics has a Young's modulus of 58.48 GPa and the polyimide film has a Young's modulus of 3.4 GPa. That is, the cover plate 16 which covers the upper surface of the actuator plate 15 has a higher stiffness than the nozzle plate 14 which covers the lower surface of the actuator plate 15. The material of the cover plate 16 preferably has a Young's modulus of not less than 40 GPa. The material of the nozzle plate 14 preferably has a Young's modulus in the range of 1.5 GPa to 30 GPa. When the nozzle plate 14 has a Young's modulus of less than 1.5 GPa, the nozzle plate 14 bruises easily when making contact with the recording medium S, and the reliability thereof is therefore reduced. On the other hand, when the nozzle plate 14 has a Young's modulus of more than 30 GPa, vibration is transmitted between nozzle holes 13 that are adjacent to each other, and crosstalk is thereby likely to occur.

The liquid jet head 4 is driven in the following manner. First, ink which has been supplied from the ink supply unit 5 to the liquid supply chamber 76 flows into the liquid jet channels 12A through the first slits 76a. Then, the ink flows from the liquid jet channels 12A to the liquid discharge chamber 77 through the second slits 77a. When a drive signal is applied to the active electrodes 74B in the state where ink is supplied to and discharged from the liquid jet channels 12A in this manner, thickness-slide deformation is caused in the piezoelectric bodies 17 which define the respective liquid jet channels 12A. Accordingly, pressure waves are generated in ink filled inside the liquid jet channels 12A. The ink is ejected from the nozzle holes 13 by the pressure waves to record a character or a figure on the recording medium S. Since the common electrodes 74A and the active electrodes 74B are separated from the bottom surfaces of the liquid jet channels 12A and the dummy channels 12B, namely, the upper surface of the nozzle plate 14, the pressure waves induced in ink are stabilized, thereby enabling ink droplets to be stably ejected. In the present embodiment, the liquid supply chamber 76 is arranged on the same side as the common terminals 75A and the active terminals 75B, and the liquid discharge chamber 77 is arranged on the other side. However, the arrangement of the liquid supply chamber 76 and the liquid discharge chamber 77 may be reversed.

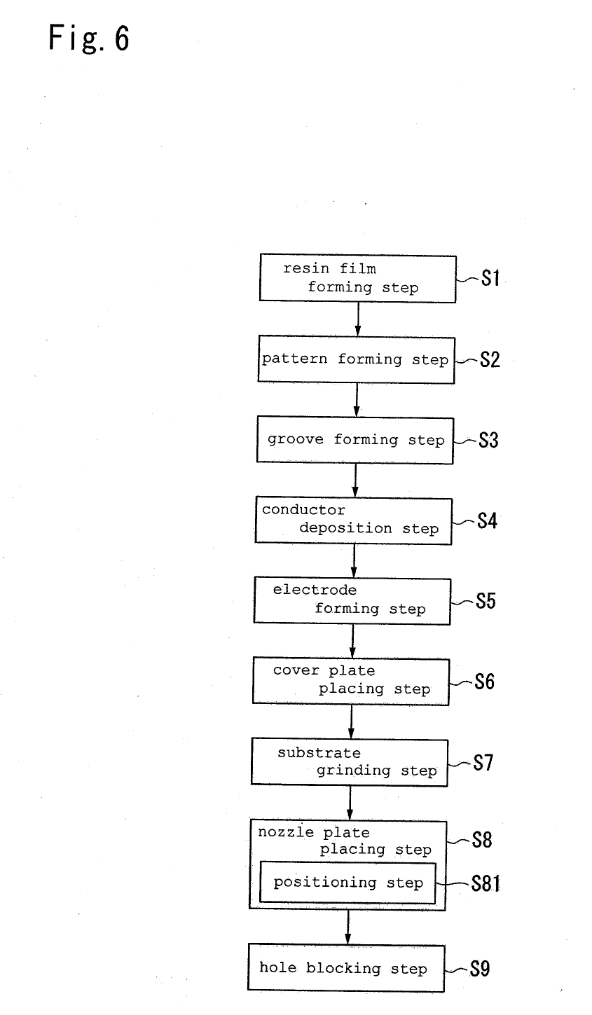

FIG. 6 is a flowchart illustrating main steps of a method of manufacturing the head chip 41 in the present embodiment. This method includes a resin film forming step S1 for forming a photosensitive resin film 82 on a first surface (an upper surface in the drawings) of a piezoelectric substrate 81 that forms the actuator plate 15; a pattern forming step S2 for forming a pattern of the resin film 82 by exposure and development; a groove forming step S3 for forming a plurality of grooves 83 on the first surface of the piezoelectric substrate 81; a conductor deposition step S4 for depositing a conductor 84 on the first surface of the piezoelectric substrate 81 from a direction that is inclined toward a direction perpendicular to the longitudinal direction of the grooves 83 with respect to the normal direction of the first surface of the piezoelectric substrate 81; an electrode forming step S5 for forming the common electrodes 74A and the active electrodes 74B by patterning the conductor 84; a cover plate placing step S6 for placing the cover plate 16 on the first surface of the piezoelectric substrate 81; a substrate grinding step S7 for grinding a second surface of the piezoelectric substrate 81; a nozzle plate placing step S8 for placing the nozzle plate 14 on the ground second surface of the piezoelectric substrate 81; and a hole blocking step S9 for blocking a through hole as a positioning reference 87 which will be described later.

In the resin film forming step S1, the photosensitive resin film 82 (see FIG. 7) is formed on the upper surface of the piezoelectric substrate 81. The piezoelectric substrate 81 is formed of PZT ceramics. The resin film 82 is formed by applying a resist film onto the piezoelectric substrate 81. The resin film 82 may be formed of a photosensitive resin film.

In the pattern forming step S2, a pattern of the resin film 82 is first formed by exposure and development. Then, a part of the resin film 82 is removed in regions on which the common terminals 75A and the active terminals 75B are to be formed, and the other part of the resin film 82 is left in regions on which the common terminals 75A and the active terminals 75B are not to be formed, in order to later perform patterning of the common terminals 75A and the active terminals 75B by lift-off.

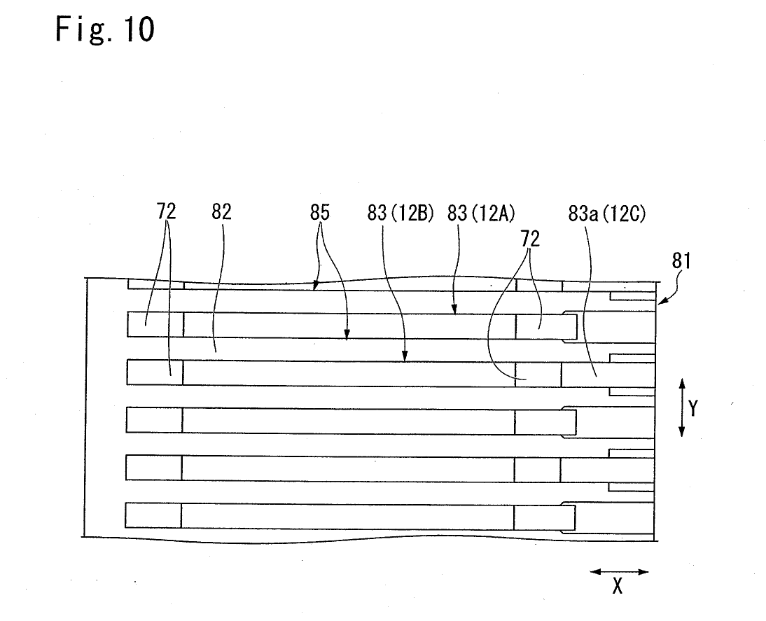

Referring to FIGS. 7 to 10, in the groove forming step S3, the grooves 83 which are the bases of the liquid jet channels 12A and the dummy channels 12B are formed on the piezoelectric substrate 81 by the dicing blade 71. The dicing blade 71 moves downward from a position above the piezoelectric substrate 81 that is horizontally arranged to a position which is to be a first end on the first side in the X direction of each of the grooves 83 on the upper surface of the piezoelectric substrate 81. Then, a part of the piezoelectric substrate 81 on this position is ground by the dicing blade 71 up to a predetermined depth. The predetermined depth is deeper than a final depth of the liquid jet channels 12A and the dummy channels 12B formed in the substrate grinding step S7, the final depth being indicated by a two-dot chain line Z, but does not reach the lower surface of the piezoelectric substrate 81.

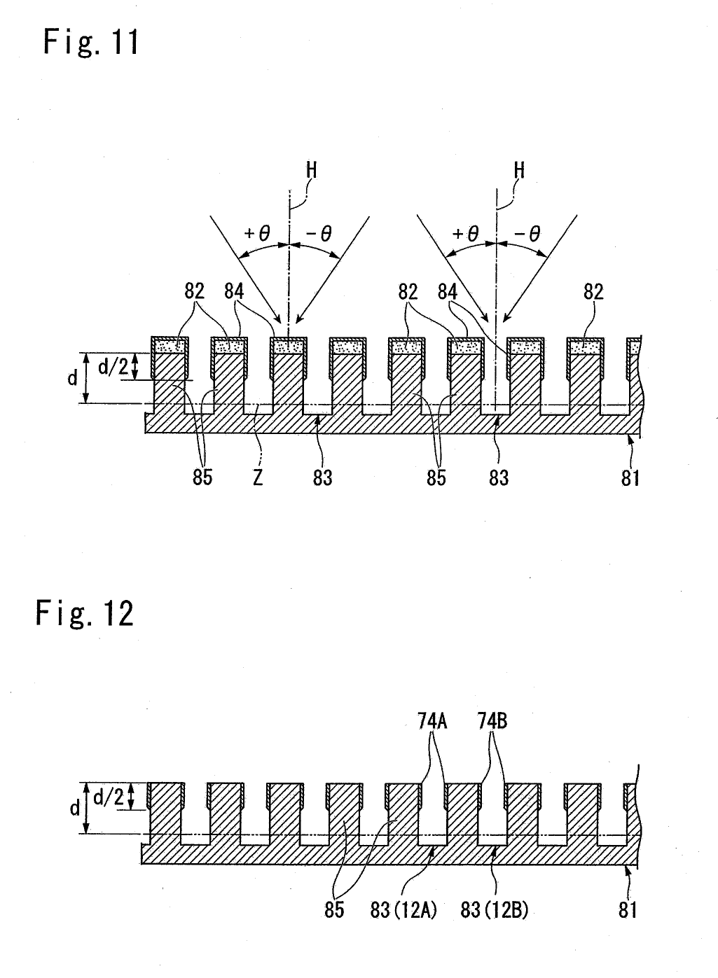

Then, the dicing blade 71 horizontally moves toward the second side in the X direction along the upper surface of the piezoelectric substrate 81 to form the groove 83 having the predetermined depth. After the dicing blade 71 reaches a position that is to be a second end on the second side in the X direction of the groove 83, the dicing blade 71 moves upward so as to escape from the piezoelectric substrate 81. The dicing blade 71 repeatedly forms each of the grooves 83 while displacing in the Y direction to form the grooves 83 arranged in parallel to each other (see FIG. 11).

Referring to FIG. 9, the dicing blade 71 forms a shallow groove 83a which is the base of the shallow groove 12C up to an outer end in the X direction of the piezoelectric substrate 81, the outer end being positioned on the second side in the X direction, in each of grooves 83 which are the bases of the dummy channels 12B. The patterned resin film 82 is formed on the upper surface of the piezoelectric substrate 81.

The upper surface of the piezoelectric substrate 81 is ground by the dicing blade 71 up to a depth deeper than the final depth of the liquid jet channels 12A and the dummy channels 12B indicated by the two-dot chain line Z. Accordingly, a width W in the X direction (see FIG. 8) of the arc-shaped bottom surfaces 72 of the liquid jet channels 12A and the dummy channels 12B is made narrow in comparison with the case where the upper surface of the piezoelectric substrate 81 is ground up to the depth indicated by the two-dot chain line Z. This makes it easy to ensure the effective width in the X direction of the liquid jet channels 12A and the dummy channels 12B. As a result, the piezoelectric substrate 81 can be down-sized, and the yield when obtaining the piezoelectric substrate 81 from a piezoelectric body wafer is improved.

Referring to FIG. 11, in the conductor deposition step S4, the conductor 84 is deposited on the upper surface of the piezoelectric substrate 81 from two directions that are respectively inclined toward a direction perpendicular to the longitudinal direction (X direction) of the grooves 83 by angles +θ and −θ with respect to the normal line H of the first surface of the piezoelectric substrate 81. In the present embodiment, the conductor 84 is deposited up to a depth that is approximately half a depth d (d/2), the depth d being defined as a distance between the first surfaces of walls 85 which are formed between the grooves 83 and are the bases of the piezoelectric bodies 17 and the two-dot chain line Z.

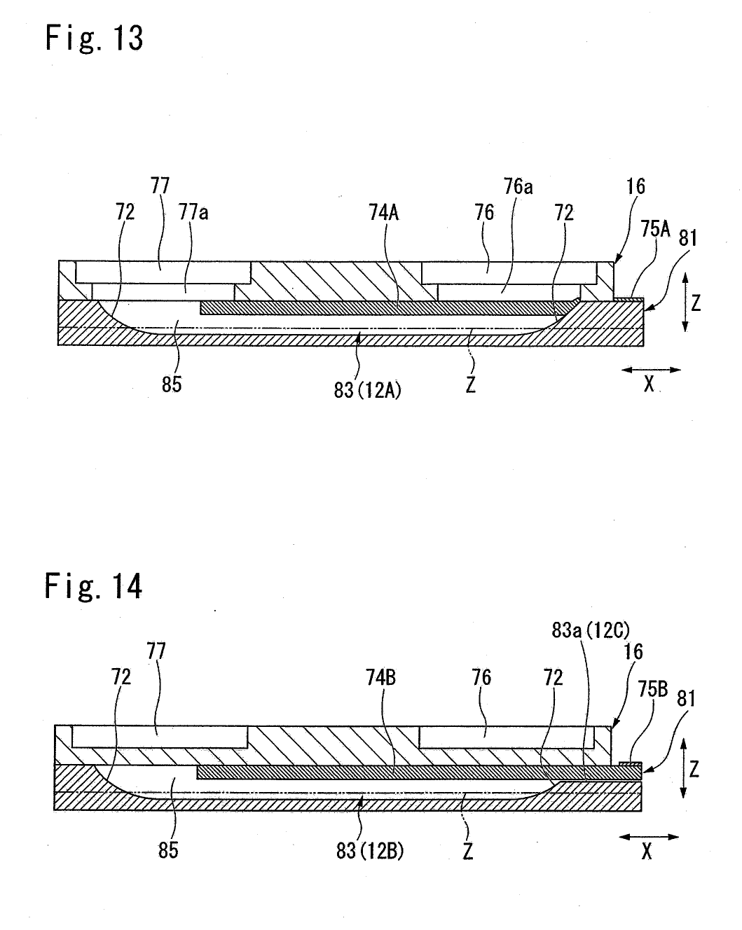

The lower edge of the conductor 84 is positioned above bottom surfaces of the shallow grooves 83a. Therefore, the conductor 84 is not deposited on the bottom surfaces of the shallow grooves 83a. On the other hand, in grooves 83 that are the bases of the liquid jet channels 12A, the conductor 84 is deposited on the upper part of arc-shaped bottom surfaces 72 located on the second side in the X direction, the upper part being shallower than the depth d/2 (see FIG. 13).

The conductor 84 may be formed up to a region that is deeper than the depth d/2 as long as the region is positioned above the two-dot chain line Z. In other words, the lower edges of the common electrodes 74A and the active electrodes 74B which are formed from the conductor 84 formed by oblique deposition may be formed within a range that is positioned above the two-dot chain line Z as well as deeper than the depth d/2. The common electrodes 74A and the active electrode 74B are separated from the bottom surfaces of the liquid jet channels 12A and the dummy channels 12B which are formed from the grooves 83 (the upper surface of the nozzle plate 14 in this example), thereby achieving stable ejection of liquid droplets as described above.

Referring to FIG. 12, in the electrode forming step S5, the conductor 84 is patterned to form the common electrodes 74A and the active electrodes 74B. That is, a part of the conductor 84 deposited on the upper surface of the resin film 82 is removed together with the resin film 82 by lift-off for removing the resin film 82. As a result, the conductor 84 deposited on opposite side surfaces of each of the walls 85 formed between the grooves 83 is separated into two parts to form the common electrode 74A and the active electrode 74B.

In the electrode forming step S5, the common terminals 75A and the active terminals 75B are also formed at the same time of forming the common electrodes 74A and the active electrodes 74B (see FIGS. 13 and 14). At this point, in all of the common electrodes 74A which are formed on the opposite inner surfaces of the liquid jet channels 12A, a pair of common electrodes 74A located inside each of the liquid jet channels 12A are electrically connected to each other. On the other hand, in all of the active electrodes 74B which are formed on the opposite inner surfaces of the dummy channels 12B, a pair of active electrodes 74B located inside each of the dummy channels 12B are electrically separated from each other. However, a pair of active electrodes 74B between which a liquid jet channel 12A is interposed are electrically connected to each other. As a result, the walls 85 (piezoelectric bodies 17) which form the liquid jet channels 12A can be driven at the same time.

Referring to FIGS. 13 and 14, in the cover plate placing step S6, the cover plate 16 is bonded to the upper surface of the piezoelectric substrate 81 with adhesive or the like after the electrode forming step S5. As a result, the upper ends of the walls 85 formed between the grooves 83 of the piezoelectric substrate 81 are integrally coupled to each other through the cover plate 16.

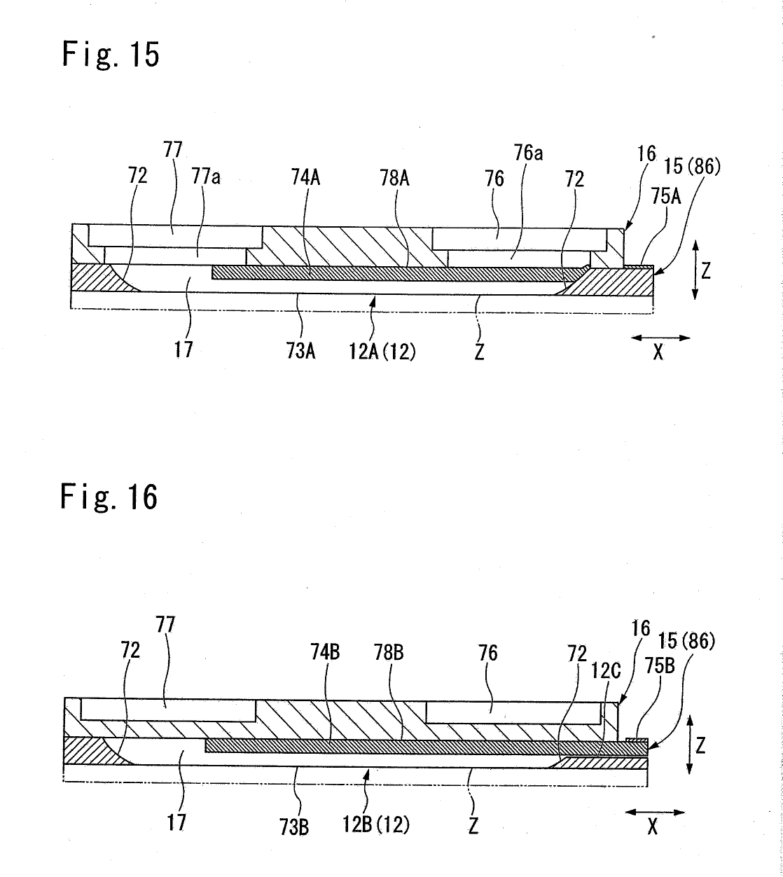

Referring to FIGS. 15 and 16, in the substrate grinding step S7, the lower surface of the piezoelectric substrate 81 is ground up to a position indicated by the two-dot chain line Z. As a result, the grooves 83 penetrate the piezoelectric substrate 81 from the upper surface through the lower surface thereof, and are formed into the liquid jet channels 12A and the dummy channels 12B each having the depth d. At this point, the lower ends of the walls 85 formed between the grooves 83 are separated from each other. On the other hand, the upper ends of the walls 85 are coupled to each other by being bonding to the cover plate 16. In addition, the piezoelectric substrate 81 is left on both ends in the X direction of the grooves 83. Therefore, the piezoelectric substrate 81 is not disassembled in the substrate grinding step S7. In the following description, the bonded body of the actuator plate 15 and the cover plate 16 is referred to as a plate bonded body 86.

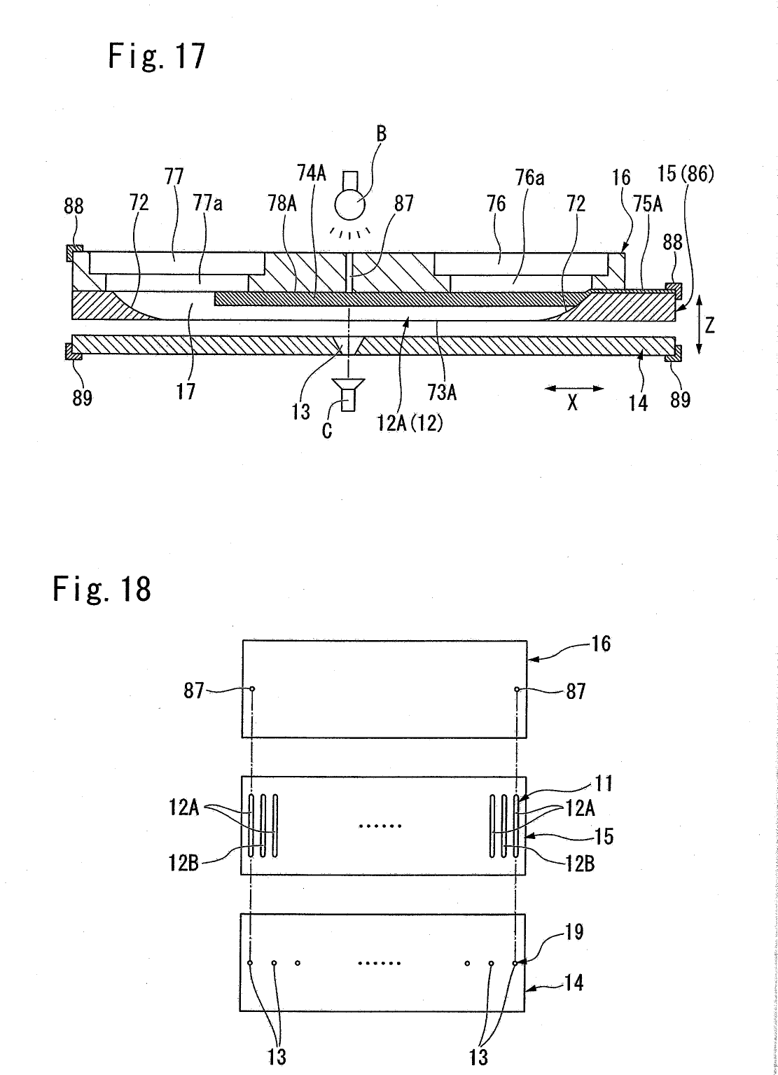

Referring to FIG. 17, in the nozzle plate placing step S8, the bonding position of the nozzle plate 14 with respect to the plate bonded body 86 is determined so that each of the nozzle holes 13 is positioned on the center in the longitudinal direction of each of the liquid jet channels 12A. In the liquid circulation type head chip 41, each of the liquid jet channels 12A including the bonded part between the actuator plate 15 and the cover plate 16 (corresponding to a pump area of the liquid jet channel 12A) is symmetrically formed with respect to the center in the longitudinal direction thereof. It is preferred to arrange each of the nozzle holes 13 on the center in the longitudinal direction of each of the liquid jet channels 12A in order to stabilize the liquid droplet ejection characteristics.

In the present embodiment, both ends of the nozzle array 19 are imaged by a camera C from underneath. The alignment between the plate bonded body 86 and the nozzle plate 14 is performed by image recognition on the basis of the imaged data. The positioning of the nozzle holes 13 is performed by detecting (visually confirming), when viewing nozzle holes 13 located on the both ends of the nozzle array 19, positioning references 87 which are formed on the cover plate 16 through the nozzle holes 13 and liquid jet channels 12A above the nozzle holes 13.

Each of the positioning references 87 is provided on the cover plate 16 at a position that faces each of the nozzle holes 13 located on the both ends of the nozzle array 19 in the axis direction of the nozzle hole 13, namely, a position that is directly above the center in the longitudinal direction of the corresponding liquid jet channel 12A. When the positioning references 87 are visually confirmed from underneath through the nozzle holes 13, each of the nozzle holes 13 is determined to be positioned below the center in the longitudinal direction of each of the liquid jet channels 12A. The nozzle plate placing step S8 includes a positioning step S81 for positioning the nozzle plate 14 with respect to the plate bonded body 86.

The positioning reference 87 illustrated in FIG. 17 is a through hole that vertically penetrates the cover plates 16. The positioning reference 87 can be easily detected even in a dark working environment by visually confirming light of a backlight B through the nozzle hole 13. In this example, after the nozzle plate placing step S8, the hole blocking step S9 for filling up the through hole to block is performed.

Each of the positioning reference 87 is not limited to a through hole, and may, for example, has various forms such as a light reflection portion formed by metal deposition or the like, a light transmission portion formed by transparentizing or thinning, and a projection portion and a recessed portion. In the case of the light reflection portion and the light transmission portion, it is easy to detect the positioning reference 87 as in the case of the through hole, and the hole blocking step S9 is not necessary. In the case of the projection portion and the recessed portion, the positioning reference 87 can be formed relatively easily.

The positioning references 87 are formed to have a size that is the same as or smaller than the size of the nozzle holes 13. The positions in the Y direction of the positioning references 87 are the same as the positions of the nozzle holes 13 located on the both ends of the nozzle array 19 and the positions of the liquid jet channels 12A located on the both ends of the channel group 11 (see FIG. 18). In FIG. 8, although the liquid jet channels 12A are arranged on the right and left ends of the channel group 11, the dummy channels 12B can also be arranged thereon.

The positioning references 87 preferably have a size that is the same as or smaller than the size of the nozzle holes 13 at least in the longitudinal direction of the liquid jet channels 12A (X direction) in order to arrange each of the nozzle holes 13 on the center in the longitudinal direction of each of the liquid jet channels 12A. However, the size of the positioning references 87 in the direction perpendicular to the liquid jet channels 12A (Y direction) is relatively flexible. For example, each of the positioning references 87 can have a size extending across a plurality of nozzle holes 13. Specifically, the width in the X direction of the positioning references 87 can be made smaller than the diameter in the X direction of the nozzle holes 13, and the width in the Y direction of the positioning references 87 can be made long in the Y direction than the diameter in the X direction of the nozzle holes 13 or the width in the X direction of the positioning references 87 to form the positioning references 87 into long grooves.

The positioning references 87 are previously provided on the cover plate 16 before the cover plate placing step S6 or provided after the cover plate placing step S6. When the positioning references 87 are previously provided, it is easy to provide the positioning references 87 in the cover plate 16. On the other hand, when the positioning references 87 are provided after the cover plate placing step S6, it is easy to provide the positioning references 87 so as to be positioned on the centers in the longitudinal direction of the liquid jet channels 12A.

The nozzle plate 14 is bonded to the plate bonded body 86 with each of the nozzle holes 13 directly positioned on the center in the longitudinal direction of each of the liquid jet channels 12A using the positioning references 87. As a result, it is possible to more accurately arrange each of the nozzle holes 13 on the center in the longitudinal direction of each of the liquid jet channels 12A while eliminating the influence of tolerance between the nozzle holes 13 and the positioning references 87 as well as reducing the influence of thermal deformation of the nozzle plate 14.

In each of the liquid jet channels 12A, a pressure wave is generated due to deformation of the piezoelectric bodies 17 located on both sides of the liquid jet channel 12A, ink filled inside the liquid jet channel 12A is ejected as liquid droplets from the corresponding nozzle hole 13. Each of the liquid jet channels 12A is symmetrically formed with respect to the center thereof, and each of the nozzle holes 13 is arranged on the center, thereby making it possible to efficiently and stably eject liquid droplets.

In the nozzle plate placing step S8, at least one of a support jig 88 for supporting the plate bonded body 86 and a support jig 89 for supporting the nozzle plate 14 performs relative alignment between the plate bonded body 86 and the nozzle plate 14 in order to detect the positioning references 87 through the nozzle holes 13 and the liquid jet channels 12A using the camera C.

The alignment between the plate bonded body 86 and the nozzle plate 14 is performed in the X direction and the Y direction. However, when positioning the nozzle plate 14 using a plurality of nozzle holes 13, the alignment can be performed also in a rotation direction about the axis along the Z direction.

When the camera C detects the positioning references 87 on the both ends of the nozzle array 19 by relative movement between the support jig 88 and the support jig 89, it is directly recognized that each of the nozzle holes 13 is arranged on the center in the longitudinal direction of each of the liquid jet channels 12A, and the alignment between the plate bonded body 86 and the nozzle plate 14 in a direction along the planes thereof is completed.

In such a state, the plate bonded body 86 and the nozzle plate 14 are put close to each other in a direction perpendicular to the planes thereof (Z direction) and bonded to each other. As a result, an assembly in which each of the nozzle holes 13 is accurately arranged on the center in the longitudinal direction of each of the liquid jet channels 12A is completed.

By directly positioning each of the nozzle holes 13 located on the both ends of the nozzle array 19 on the center in the longitudinal direction of the corresponding liquid jet channel 12A in this manner, it is possible to eliminate the influence of the tolerance between the nozzle holes 13 and the positioning references 87 on the positioning accuracy and reducing the influence of thermal deformation of the nozzle plate 14 on the positioning accuracy even when the environmental temperature changes or when the nozzle plate 14 that is made of a plastic material is used. As a result, the entire nozzle array 19 can be easily and reliably arranged on the centers of the liquid jet channels 12A.

The positioning references 87 are formed after forming the liquid supply chamber 76 and the liquid discharge chamber 77. When a potential difference is applied between the electrodes 74, a part of each of the liquid jet channels 12A, the part being driven by the piezoelectric bodies 17, is substantially the same as an area in which the liquid jet channels 12A are closed by the cover plate 16. Therefore, in order to improve the accuracy of the position of the center of the part driven by the piezoelectric bodies 17, after forming the liquid supply chamber 76 and the liquid discharge chamber 77, each of the positioning references 87 is formed on the center of an area in which the liquid supply chamber 76 and the liquid discharge chamber 77 are not formed.

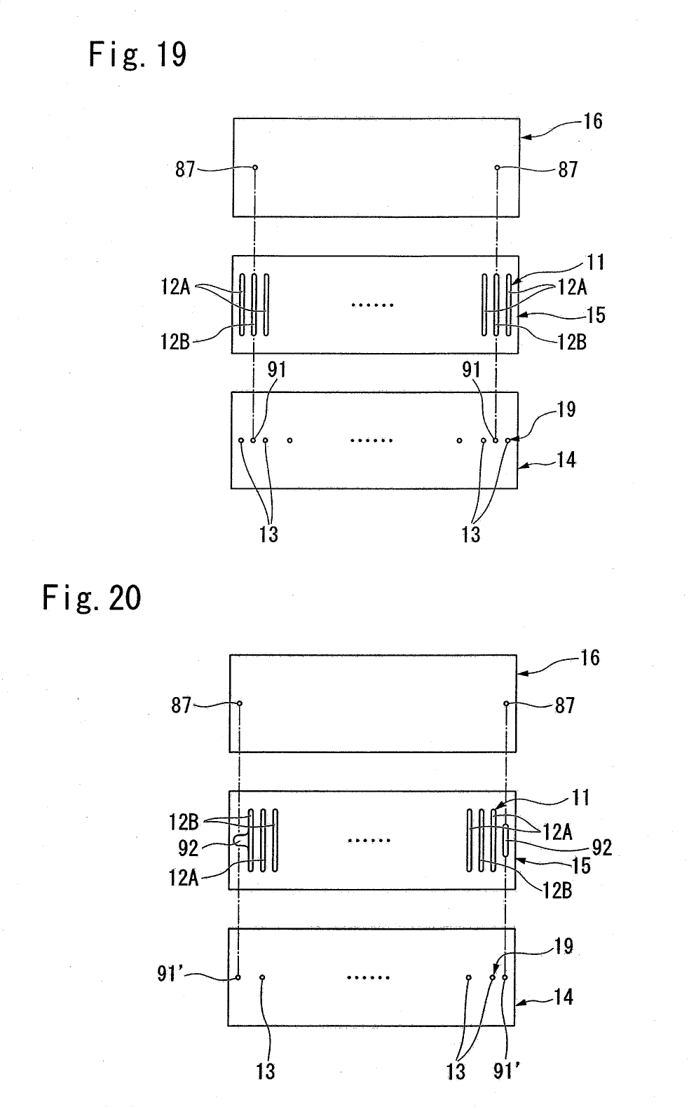

As a modified example of the present embodiment, as illustrated in FIG. 19, dummy nozzles (adjacent holes) 91 may be formed on the nozzle plate 14 at positions each directly below the center in the longitudinal direction of the corresponding dummy channel 12B between nozzle holes 13 of the nozzle array 19. Further, positioning references 87 may be formed on the cover plate 16 at positions facing the respective dummy nozzles 91. Each of the nozzle holes 13 may be determined to be arranged on the center in the longitudinal direction of each of the liquid jet channels 12A when the positioning references 87 are detected through the dummy nozzles 91 and the dummy channels (through portions) 12B from underneath. The dummy channels 12B vertically penetrate the actuator plate 15, and each of the positioning references 87 is located at the same position in the X direction as the center in the longitudinal direction of each of the liquid jet channels 12A. Since the dummy channels 12B are not filled with ink, there is a high flexibility in forming the positioning references 87 each of which faces the corresponding dummy channel 12B.

On the other hand, as illustrated in FIG. 18, when the positioning references 87 as through holes are formed at the positions each of which faces the corresponding liquid jet channel 12A, the hole blocking step S9 is performed after the nozzle plate placing step S8 as described above. In the hole blocking step S9, when, for example, manifolds corresponding to the liquid supply chamber 76 and the liquid discharge chamber 77 are bonded onto the cover plate 16 using adhesive, the holes are blocked by the adhesive. Alternatively, various methods such as the use of a sealing material may be used.

As another modified example of the present embodiment, as illustrated in FIG. 20, dummy nozzles (adjacent holes) 91′ may be formed on the nozzle plate 14 at positions that are outwardly separated from the both ends of the nozzle array 19 by a distance that is approximately equal to a pitch between the nozzle holes 13. Further, window holes (through portions) 92 may be formed on the actuator plate 15 so as to include positions facing the respective dummy nozzles 91′. Further, the positioning references 87 may be formed on the cover plate 16 at positions facing the respective dummy nozzles 91′. Each of the nozzle holes 13 may be determined to be arranged on the center in the longitudinal direction of each of the liquid jet channels 12A when the positioning references 87 are detected through the dummy nozzles 91′ and the window holes 92 from underneath. Each of the positioning references 87 is located at the same position in the X direction as the center in the longitudinal direction of each of the liquid jet channels 12A.

The dummy nozzles 91′ are preferably formed at positions that are outwardly separated from the both ends in the Y direction of the nozzle array 19 by a distance that is shorter than the pitch between the nozzle holes 13. As illustrated in the left side of FIG. 20, when a dummy channel 12B is located on the end in the Y direction of the channel group 11, a notch or a widened part may be formed on the dummy channel 12B as the window hole 92.

As described above, in the head chip 41 of the above embodiment, the cover plate 16 has the positioning references 87 at the positions each of which faces at least one of the nozzle holes 13 through at least one of the liquid jet channels 12A, or the positions each of which faces an adjacent hole (the dummy nozzle 91 or 91′) that is adjacent to any of the nozzle holes 13 formed on the nozzle plate 14 through a through portion (the dummy channel 12B or the window hole 92) formed on the actuator plate 15. The positioning reference 87 can be detected from underneath the nozzle plate 14 through the nozzle hole 13 and the liquid jet channel 12A or through the adjacent hole and the through portion.

With such a configuration, the nozzle holes 13 can be directly positioned by a method in which each of the positioning references 87 provided in the cover plate 16 is detected through the nozzle hole 13 or the adjacent hole adjacent to the nozzle hole 13, and the positioning of the nozzle holes 13 is performed by the detection. Therefore, the positioning accuracy of the nozzle holes 13 can be improved, and an excellent ejection characteristic of the head chip 41 can thereby be ensured in comparison with the case where the positioning of the nozzle holes 13 is performed by using a positioning reference away from the nozzle holes 13. Especially in the side shoot type head chip 41 in which each of the nozzle holes 13 communicates with the middle part in the longitudinal direction of each of the liquid jet channels 12A, it is important to arrange the nozzle holes 13 on the center of a pump composed of the actuator plate 15 and the cover plate 16 in controlling the ejection characteristic. Therefore, a high effect of the present invention can be achieved in such a side shoot type head chip.

A method of manufacturing the head chip 41 in the above embodiment includes the positioning step S81 for positioning the nozzle plate 14 by detecting each of the positioning references 87 provided in the cover plate 16 through at least one of the nozzle holes 13 and at least one of the liquid jet channels 12A that faces the at least one of the nozzle holes 13, or through the adjacent hole (the dummy nozzle 91 or 91′) that is adjacent to any of the nozzle holes 13 formed on the nozzle plate 14 and the through portion (the dummy channel 12B or the window hole 92) formed on the actuator plate 15.

Note that the present invention is not limited to the above embodiment. For example, the positioning references 87 may be provided on the middle part of the nozzle array 19. The positioning of the nozzle plate 14 may be performed by a single positioning reference 87. Further, three or more positioning references 87 may be provided. The positioning reference 87 may be visually confirmed by eyesight without using an imaging unit such as the camera C. The alignment by the support jigs 88 and 89 may be performed either automatically or manually.

In the piezoelectric substrate 81, a piezoelectric body can be used in at least walls each of which partitions channels adjacent to each other, and the other area can be formed of an insulator made of a non-piezoelectric body. The nozzle plate 14 can be formed by a single layer or a plurality of thin film layers. The electrodes and the terminals may be patterned not by lift-off, but by, for example, photolithography and etching after the conductor is formed by oblique deposition in the conductor deposition step.

The head chip 41 may be applied not only to the ink jet type liquid jet head 4 which ejects ink droplets onto a recording paper or the like to record a character and a figure thereon, but also to a liquid jet head that ejects a liquid material onto the surface of an element substrate to form a functional thin film thereon.

The configuration in the above embodiment is merely an example of the present invention. Therefore, various modifications can be made without departing from the scope of the invention.

What is claimed is:

1. A head chip comprising:
an actuator plate having a plurality of ejection grooves formed on a first surface of a substrate, each of the ejection grooves having a depth penetrating the substrate;
a cover plate placed on the first surface of the actuator plate, the cover plate having a liquid supply chamber communicating with the ejection grooves; and
a nozzle plate placed on a second surface of the actuator plate, the nozzle plate having a plurality of nozzle holes each communicating with the center in the longitudinal direction of each of the ejection grooves,
wherein the cover plate has at least one positioning reference for the nozzle plate at a position facing at least one of the nozzle holes through at least one of the ejection grooves, or a position facing at least one adjacent hole adjacent to any of the nozzle holes formed on the nozzle plate through at least one through portion formed on the actuator plate, and
the at least one positioning reference can be detected from underneath the nozzle plate through the at least one of the nozzle hole and the at least one of the ejection groove, or through the at least one adjacent hole and the at least one through portion.

2. The head chip according to claim 1, wherein the at least one positioning reference provided in the cover plate comprises a plurality of positioning references.

3. The head chip according to claim 1, wherein the at least one positioning reference comprises two positioning references, and the two positioning references are provided at positions facing two of the nozzle holes arranged on both ends of a nozzle array including the nozzle holes formed on the nozzle plate, or the at least one adjacent hole comprises two adjacent holes arranged on the both ends of the nozzle array and the two positioning references are provided at positions facing the two adjacent holes.

4. The head chip according to claim 1, wherein the at least one positioning reference is a through hole formed on the cover plate.

5. The head chip according to claim 1, wherein the at least one positioning reference is a light reflection portion formed on the cover plate.

6. The head chip according to claim 1, wherein the at least one positioning reference is a light transmission portion formed on the cover plate.

7. The head chip according to claim 1, wherein the at least one positioning reference is a projection portion formed on the cover plate.

8. The head chip according to claim 1, wherein the at least one positioning reference is a recessed portion formed on the cover plate.

9. The head chip according to claim 1, wherein the at least one adjacent hole comprises a plurality of adjacent holes, and the at least one positioning reference is provided so as to face plural ones of the nozzle holes or the adjacent holes.

10. A method of manufacturing a head chip, the head chip comprising:
an actuator plate having a plurality of ejection grooves formed on a first surface of a substrate, each of the ejection grooves having a depth penetrating the substrate;
a cover plate placed on the first surface of the actuator plate, the cover plate having a liquid supply chamber communicating with the ejection grooves; and
a nozzle plate placed on a second surface of the actuator plate, the nozzle plate having a plurality of nozzle holes each communicating with the center in the longitudinal direction of each of the ejection grooves,
the method comprising a positioning step for positioning the nozzle plate by detecting a positioning reference provided in the cover plate through at least one of the nozzle holes and at least one of the ejection grooves, or through an adjacent hole adjacent to any of the nozzle holes formed on the nozzle plate and a through portion formed on the actuator plate.

11. The method of manufacturing the head chip according to claim 10, further comprising a hole blocking step for blocking a through hole as the positioning reference provided in the cover plate.

12. A liquid jet head comprising:
the head chip according to claim 1;
a liquid supply/discharge unit supplying and discharging liquid to and from the ejection grooves; and
a control unit applying a drive voltage to drive electrodes formed on side walls of the ejection grooves.

13. A liquid jet apparatus comprising:
the liquid jet head according to claim 12;
a conveyance unit conveying a recording medium in a predetermined conveyance direction; and
a scanning unit moving the liquid jet head in a direction perpendicular to the conveyance direction with respect to the recording medium.
